(19) United States
(12) Patent Application Publication
(10) Pub. No.: US 2024/0397499 A1
(43) Pub. Date: Nov. 28, 2024

(54) METHODS AND APPARATUSES FOR DETERMINING FREQUENCY DOMAIN RESOURCE

(71) Applicant: LENOVO (BEIJING) LIMITED, Beijing (CN)

(72) Inventors: Hongmei Liu, Beijing (CN); Zhi Yan, Beijing (CN); Yuantao Zhang, Beijing (CN); Haiming Wang, Beijing (CN)

(21) Appl. No.: 18/695,437

(22) PCT Filed: Sep. 28, 2021
(86) PCT No.: PCT/CN2021/121383

§ 371 Date: Mar. 26, 2024

(51) Int. Cl. H04W 72/0453; H04L 5/00; H04W 84/04

(52) U.S. Cl. CPC H04W 72/0453; H04L 5/0094; H04W 84/047

(57) ABSTRACT

The present disclosure relates to methods and apparatuses for determining frequency domain resource. According to some embodiments of the present application, an integrated access and backhaul (IAB) node, includes: a receiver configured to receive, from a parent node or a central unit (CU), information indicating at least one of: a first frequency domain resource configuration associated with at least one bandwidth part (BWP) of an IAB mobile terminal (MT); a second frequency domain resource configuration associated with a resource block (RB) set configuration of an IAB distributed unit (DU); or a third frequency domain resource configuration associated with the RB set configuration of the IAB DU; and a processor configured to determine: one or more frequency domain resource for downlink or uplink communication at the IAB MT based on the first frequency domain resource configuration; and/or a frequency domain resource unit for resource allocation at a parent link and a child link of the IAB node based on at least one of the second frequency domain resource configuration and the third frequency domain resource configuration.

### TECHNICAL FIELD

Embodiments of the present application relate to wireless communication technologies, especially to methods and apparatuses for determining frequency domain resource.

### BACKGROUND OF THE INVENTION

It is agreed in RAN1 #105e that the minimum resource size for configuring the frequency domain granularity is a set of N RBs, i.e. RB set, and the candidate values for N may include: {4, 8, 16, other values}, where N is at least the number of PRBs that are corresponding to the mobile terminal (MT)'s number of physical resource bocks (PRB) of a resource bock group (RBG)).

It is agreed in RAN1 #106e that N is a configured number of physical resource block (PRBs), and is configured by the central unit (CU), where the value for N may include: {2, 4, 8, 16, 32, 64}.

The present disclosure proposes some solutions for determining the distributed unit (DU) resource block (RB) set of an integrated access and backhaul (IAB) node.

### SUMMARY

According to some embodiments of the present application, an integrated access and backhaul (IAB) node, includes: a receiver configured to receive, from a parent node or a central unit (CU), information indicating at least one of: a first frequency domain resource configuration associated with at least one bandwidth part (BWP) of an IAB mobile terminal (MT); a second frequency domain resource configuration associated with a resource block (RB) set configuration of an IAB distributed unit (DU); or a third frequency domain resource configuration associated with the RB set configuration of the IAB DU; and a processor configured to determine: one or more frequency domain resource for downlink or uplink communication at the IAB MT based on the first frequency domain resource configuration; and/or a frequency domain resource unit for resource allocation at a parent link and a child link of the IAB node based on at least one of the second frequency domain resource configuration and the third frequency domain resource configuration. For example, the information may indicates: 1) the first frequency domain resource, 2) the second frequency domain resource, 3) the third frequency domain resource, 4) the first frequency domain resource and the second frequency domain resource, 5) the first frequency domain resource and the third frequency domain resource, 6) the second frequency domain resource and the third frequency domain resource, or 7) the first frequency domain resource, the second frequency domain resource, and the third frequency domain resource.

In some embodiments, the first frequency domain resource configuration is based on the size of a first RBG of the at least one BWP of the IAB MT.

In some embodiments, the second frequency domain resource configuration is based on the size of the first RB set of the IAB DU, and the size is different from a size of other RB sets of the IAB DU.

In some embodiments, the third frequency domain resource configuration is based on the size of a last RB set of the IAB DU, and the size is different from size of a other RB sets of the IAB DU.

In some embodiments, the first frequency domain resource is determined based on at least one of a starting boundary of the at least one BWP configuration and a reference starting boundary, and a largest RBG size among all BWPs of the IAB MT.

In some embodiments, the second frequency domain resource is determined based on at least one of a starting boundary of an IAB DU carrier, a reference starting boundary and a largest RBG size among all BWPs of the IAB MT.

In some embodiments, the third frequency domain resource is determined based on at least one of an ending boundary of an IAB DU carrier, a reference starting boundary, a largest RBG size among all BWPs of the IAB MT and an ending boundary of the at least one BWP of the IAB MT.

In some embodiments, the reference starting boundary is explicitly configured, implicitly determined based on a starting frequency domain position of a carrier, implicitly determined based on a starting frequency domain position of synchronization signal/physical broadcast channel (SSB), or implicitly determined based on starting frequency domain position of a lowest indexed BWP of the IAB MT.

In some embodiments, the second frequency domain resource is determined as hard resource in the case that the second frequency domain resource does not overlap with any PRB or any active BWP of the IAB MT.

In some embodiments, the third frequency domain resource is determined as hard resource in the case that the third frequency domain resource does not overlap with any PRB or any active BWP of the IAB MT.

In some embodiments, at least one of the first frequency domain resource, second frequency domain resource and the third frequency domain resource is applied to the time domain resource when the time domain resource is associated with frequency domain multiplexing between a parent link and a child link of the IAB node.

In some embodiments, at least one of the second frequency domain resource and the third frequency domain resource is associated with a BWP index of the IAB MT.

In some embodiments, the BWP index includes a downlink (DL) BWP index, an uplink (UL) BWP index, or a joint index based on the DL BWP index and the UL BWP index.

In some embodiments, the receiver is further configured to: receive, from the CU or the parent node, a mapping relationship between the BWP index and at least one of the second frequency domain resource and the third frequency domain resource.

In some embodiments, the processor is further configured to determine the BWP index to be a DL active BWP index or a UL active BWP index is based on a transmission direction on a parent link of the network node.

In some embodiments, the first frequency domain resource, the second frequency domain resource, and the third frequency domain resource is indicated by a number of PRBs associated with a reference SCS.

In some embodiments, the SCS is explicitly configured, implicitly determined based on SCS of the IAB MT BWP, or SCS of an IAB MT BWP with the lowest frequency band.

According to some embodiments of the present application, an integrated access and backhaul (IAB) node, includes: a transmitter configured to transmit information to a parent node or a central unit (CU), and the information including at least one of the following: one or more bandwidth part (BWP) configurations; or a physical resource block (PRB) number associated with a reference subcarrier spacing (SCS).

In some embodiments, the one or more BWP configurations include at least one of the following: a BWP size for a BWP; a SCS associated with a BWP; and a resource block group (RBG) configuration of a BWP.

In some embodiments, the information is used to determine a size of a resource block (RB) set for a IAB district unit (DU).

In some embodiments, the transmitter is further configured to transmit the reference SCS with the PRB number.

According to some embodiments of the present application, an integrated access and backhaul (IAB) node, includes: a transmitter configured to transmit, to a child node or a distributed unit (DU), information indicating at least one of: a first frequency domain resource configuration associated with at least one bandwidth part (BWP) of an IAB mobile terminal (MT); a second frequency domain resource configuration associated with a resource block (RB) set configuration of an IAB distributed unit (DU); or a third frequency domain resource configuration associated with the RB set configuration of the IAB DU.

In some embodiments, the first frequency domain resource configuration is based on the size of a first RBG of the at least one BWP of the IAB MT.

In some embodiments, the second frequency domain resource configuration is based on the size of the first RB set of the IAB DU, and the size is different from a size of other RB sets of the IAB DU.

In some embodiments, the third frequency domain resource configuration is based on the size of a last RB set of the IAB DU, and the size is different from size of a other RB sets of the IAB DU.

In some embodiments, the first frequency domain resource is determined based on at least one of a starting boundary of the at least one BWP configuration and a reference starting boundary, and a largest RBG size among all BWPs of the IAB MT.

In some embodiments, the second frequency domain resource is determined based on at least one of a starting boundary of an IAB DU carrier, a reference starting boundary and a largest RBG size among all BWPs of the IAB MT.

In some embodiments, the third frequency domain resource is determined based on at least one of an ending boundary of an IAB DU carrier, a reference starting boundary, a largest RBG size among all BWPs of the IAB MT, and an ending boundary of the at least one BWP of the IAB MT.

In some embodiments, the reference starting boundary is explicitly configured, implicitly determined based on a starting frequency domain position of a carrier, implicitly determined based on a starting frequency domain position of synchronization signal/physical broadcast channel (SSB), or implicitly determined based on starting frequency domain position of a lowest indexed BWP of the IAB MT.

In some embodiments, the second frequency domain resource is determined as hard resource in the case that the second frequency domain resource does not overlap with any PRB or any active BWP of the IAB MT.

In some embodiments, the third frequency domain resource is determined as hard resource in the case that the third frequency domain resource does not overlap with any PRB or any active BWP of the IAB MT.

In some embodiments, at least one of the first frequency domain resource, second frequency domain resource and the third frequency domain resource is applied to the time domain resource when the time domain resource is associated with frequency domain multiplexing between a parent link and a child link of the IAB node.

In some embodiments, at least one of the second frequency domain resource and the third frequency domain resource is associated with a BWP index of the IAB MT.

In some embodiments, the BWP index includes a downlink (DL) BWP index, an uplink (UL) BWP index, or a joint index based on the DL BWP index and the UL BWP index.

In some embodiments, the transmitter is further configured to: transmit, to the DU or the child node, a mapping relationship between the BWP index and at least one of the second frequency domain resource and the third frequency domain resource.

In some embodiments, the first frequency domain resource, the second frequency domain resource, and the third frequency domain resource is indicated by a number of PRBs associated with a reference SCS.

In some embodiments, the SCS is explicitly configured, implicitly determined based on SCS of the IAB MT BWP, or SCS of an IAB MT BWP with the lowest frequency band.

According to some embodiments of the present application, an integrated access and backhaul (IAB) node, includes: a receiver configured to receive information to a parent node or a central unit (CU), and the information including at least one of the following: one or more bandwidth part (BWP) configurations; or a physical resource block (PRB) number associated with a reference subcarrier spacing (SCS).

In some embodiments, the one or more BWP configurations include at least one of the following: a BWP size for a BWP; a SCS associated with a BWP; and a resource block group (RBG) configuration of a BWP.

In some embodiments, the information is used to determine a size of a resource block (RB) set for a IAB district unit (DU).

In some embodiments, the reference SCS is determined based on frequency band, or a SCS of a BWP with lowest index.

According to some embodiments of the present application, a method for determining frequency domain resource, includes: receiving, from a parent node or a central unit (CU), information indicating at least one of: a first frequency domain resource configuration associated with at least one bandwidth part (BWP) of an IAB mobile terminal (MT); a second frequency domain resource configuration associated with a resource block (RB) set configuration of an IAB distributed unit (DU); or a third frequency domain resource configuration associated with the RB set configuration of the IAB DU; and determining: one or more frequency domain resource for downlink or uplink communication at the IAB MT based on the first frequency domain resource configuration; and/or a frequency domain resource unit for resource allocation at a parent link and a child link of the IAB node based on at least one of the second frequency domain resource configuration and the third frequency domain resource configuration.

In some embodiments, the first frequency domain resource configuration is based on the size of a first RBG of the at least one BWP of the IAB MT.

In some embodiments, the second frequency domain resource configuration is based on the size of the first RB set of the IAB DU, and the size is different from a size of other RB sets of the IAB DU.

In some embodiments, the third frequency domain resource configuration is based on the size of a last RB set of the IAB DU, and the size is different from size of a other RB sets of the IAB DU.

In some embodiments, the first frequency domain resource is determined based on at least one of a starting boundary of the at least one BWP configuration and a reference starting boundary, and a largest RBG size among all BWPs of the IAB MT.

In some embodiments, the second frequency domain resource is determined based on at least one of a starting boundary of an IAB DU carrier, a reference starting boundary and a largest RBG size among all BWPs of the IAB MT.

In some embodiments, the third frequency domain resource is determined based on at least one of an ending boundary of an IAB DU carrier, a reference starting boundary, a largest RBG size among all BWPs of the IAB MT, and an ending boundary of the at least one BWP of the IAB MT.

In some embodiments, wherein the reference starting boundary is explicitly configured, implicitly determined based on a starting frequency domain position of a carrier, implicitly determined based on a starting frequency domain position of synchronization signal/physical broadcast channel (SSB), or implicitly determined based on starting frequency domain position of a lowest indexed BWP of the IAB MT.

In some embodiments, the second frequency domain resource is determined as hard resource in the case that the second frequency domain resource does not overlap with any PRB or any active BWP of the IAB MT.

In some embodiments, the third frequency domain resource is determined as hard resource in the case that the third frequency domain resource does not overlap with any PRB or any active BWP of the IAB MT.

In some embodiments, at least one of the first frequency domain resource, second frequency domain resource and the third frequency domain resource is applied to the time domain resource when the time domain resource is associated with frequency domain multiplexing between a parent link and a child link of the IAB node.

In some embodiments, at least one of the second frequency domain resource and the third frequency domain resource is associated with a BWP index of the IAB MT.

In some embodiments, the BWP index includes a downlink (DL) BWP index, an uplink (UL) BWP index, or a joint index based on the DL BWP index and the UL BWP index.

In some embodiments, the method further includes receiving, from the CU or the parent node, a mapping relationship between the BWP index and at least one of the second frequency domain resource and the third frequency domain resource.

In some embodiments, the method further includes determining the BWP index to be a DL active BWP index or a UL active BWP index is based on a transmission direction on a parent link of the network node.

In some embodiments, the first frequency domain resource, the second frequency domain resource, and the third frequency domain resource is indicated by a number of PRBs associated with a reference SCS.

In some embodiments, the SCS is explicitly configured, implicitly determined based on SCS of the IAB MT BWP, or SCS of an IAB MT BWP with the lowest frequency band.

According to some embodiments of the present application, a method for determining frequency domain resource, includes: transmitting information to a parent node or a central unit (CU), and the information including at least one of the following: one or more bandwidth part (BWP) configurations; or a physical resource block (PRB) number associated with a reference subcarrier spacing (SCS).

In some embodiments, the one or more BWP configurations include at least one of the following: a BWP size for a BWP; a SCS associated with a BWP; and a resource block group (RBG) configuration of a BWP.

In some embodiments, the information is used to determine a size of a resource block (RB) set for an IAB district unit (DU).

In some embodiments, the transmitter is further configured to transmit the reference SCS with the PRB number.

According to some embodiments of the present application, a method for determining frequency domain resource, includes: transmitting, to a child node or a distributed unit (DU), information indicating at least one of: a first frequency domain resource configuration associated with at least one bandwidth part (BWP) of an IAB mobile terminal (MT); a second frequency domain resource configuration associated with a resource block (RB) set configuration of an IAB distributed unit (DU); or a third frequency domain resource configuration associated with the RB set configuration of the IAB DU.

In some embodiments, the first frequency domain resource configuration is based on the size of a first RBG of the at least one BWP of the IAB MT.

In some embodiments, the second frequency domain resource configuration is based on the size of the first RB set of the IAB DU, and the size is different from a size of other RB sets of the IAB DU.

In some embodiments, the third frequency domain resource configuration is based on the size of a last RB set of the IAB DU, and the size is different from size of a other RB sets of the IAB DU.

In some embodiments, the first frequency domain resource is determined based on at least one of a starting boundary of the at least one BWP configuration and a reference starting boundary, and a largest RBG size among all BWPs of the IAB MT.

In some embodiments, the second frequency domain resource is determined based on at least one of a starting boundary of an IAB DU carrier, a reference starting boundary and a largest RBG size among all BWPs of the IAB MT.

In some embodiments, the third frequency domain resource is determined based on at least one of an ending boundary of an IAB DU carrier, a reference starting boundary, a largest RBG size among all BWPs of the IAB MT, and an ending boundary of the at least one BWP of the IAB MT.

In some embodiments, the reference starting boundary is explicitly configured, implicitly determined based on a starting frequency domain position of a carrier, implicitly determined based on a starting frequency domain position of synchronization signal/physical broadcast channel (SSB), or implicitly determined based on starting frequency domain position of a lowest indexed BWP of the IAB MT.

In some embodiments, the second frequency domain resource is determined as hard resource in the case that the second frequency domain resource does not overlap with any PRB or any active BWP of the IAB MT.

In some embodiments, the third frequency domain resource is determined as hard resource in the case that the third frequency domain resource does not overlap with any PRB or any active BWP of the IAB MT.

In some embodiments, at least one of the first frequency domain resource, second frequency domain resource and the third frequency domain resource is applied to the time domain resource when the time domain resource is associated with frequency domain multiplexing between a parent link and a child link of the IAB node.

In some embodiments, at least one of the second frequency domain resource and the third frequency domain resource is associated with a BWP index of the IAB MT.

In some embodiments, the BWP index includes a downlink (DL) BWP index, an uplink (UL) BWP index, or a joint index based on the DL BWP index and the UL BWP index.

In some embodiments, the method further includes: transmitting, to the DU or the child node, a mapping relationship between the BWP index and at least one of the second frequency domain resource and the third frequency domain resource.

In some embodiments, the first frequency domain resource, the second frequency domain resource, and the third frequency domain resource is indicated by a number of PRBs associated with a reference SCS.

In some embodiments, the SCS is explicitly configured, implicitly determined based on SCS of the IAB MT BWP, or SCS of an IAB MT BWP with the lowest frequency band.

According to some embodiments of the present application, a method for determining frequency domain resource, includes: receiving information to a parent node or a central unit (CU), and the information including at least one of the following: one or more bandwidth part (BWP) configurations; or a physical resource block (PRB) number associated with a reference subcarrier spacing (SCS).

In some embodiments, the one or more BWP configurations includes at least one of the following: a BWP size for a BWP; a SCS associated with a BWP; and a resource block group (RBG) configuration of a BWP.

In some embodiments, the information is used to determine a size of a resource block (RB) set for an IAB district unit (DU).

In some embodiments, the reference SCS is determined based on frequency band, or a SCS of a BWP with lowest index.

### BRIEF DESCRIPTION OF THE DRAWINGS

FIG. 1 illustrates an exemplary IAB system according to some embodiments of the present disclosure.

FIG. 2 illustrates an exemplary description of the links between the IAB nodes according to some embodiments of the present disclosure.

FIG. 3 illustrates an exemplary description of determining the DU RB set configuration according to some embodiments of the present disclosure.

FIG. 4 illustrates another exemplary description of determining the DU RB configuration set according to some embodiments of the present disclosure.

FIG. 5 illustrates another exemplary description of determining the DU RB configuration set according to some embodiments of the present disclosure.

FIG. 6 illustrates an exemplary description of determining the DU RB set configuration according to some embodiments of the present disclosure.

FIG. 7 illustrates a method for wireless communication according to some embodiments of the subject disclosure.

FIG. 8 illustrates an exemplary block diagram of an apparatus 800 according to some embodiments of the present disclosure.

### DETAILED DESCRIPTION

The detailed description of the appended drawings is intended as a description of the currently preferred embodiments of the present application and is not intended to represent the only form in which the present application may be practiced. It should be understood that the same or equivalent functions may be accomplished by different embodiments that are intended to be encompassed within the spirit and scope of the present disclosure.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present application, examples of which are illustrated in the accompanying drawings. To facilitate understanding, embodiments are provided under specific network architecture and new service scenarios, such as 3GPP 5G, 3GPP long term evolution (LTE) Release 8 and so on. Persons skilled in the art know very well that, with the development of network architecture and new service scenarios, the embodiments in the present application are also applicable to similar technical problems; and moreover, the terminologies recited in the present application may change, which should not affect the principle of the present disclosure.

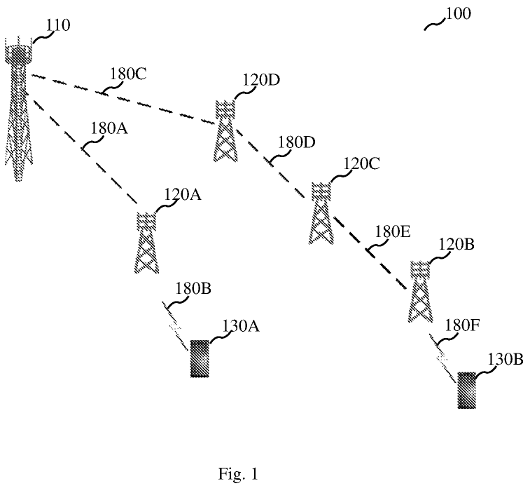

FIG. 1 illustrates an exemplary IAB system 100 according to some embodiments of the present application.

Referring to FIG. 1A, the IAB system 100 can include an IAB donor node (e.g., donor node 110), some IAB nodes (e.g., IAB node 120A, IAB node 120B, IAB node 120C, and IAB node 120D), and some UEs (e.g., UE 130A and UE 130B). Although merely, for simplicity, one donor node is illustrated in FIG. 1A, it is contemplated that IAB system 100 may include more donor node(s) in some other embodiments of the present application. Similarly, although merely four IAB nodes are illustrated in FIG. 1A for simplicity, it is contemplated that IAB system 100 may include more or fewer IAB nodes in some other embodiments of the present application. Although merely two UEs are illustrated in FIG. 1A for simplicity, it is contemplated that IAB system 100 may include more or fewer UEs in some other embodiments of the present application.

IAB node 120A is directly connected to donor node 110. IAB node 120D is directly connected to donor node 110. In this example, donor node 110 is a parent node of IAB node 120A, and also a parent node of IAB node 120D. IAB nodes 120A and 120D are child nodes of donor node 110. Link 180A between donor node 110 and IAB node 120A is a parent link of IAB node 120A. Link 180B between IAB node 120A and IAB node 130A is a child link of IAB node 120A. Link 180C between donor node 110 and IAB node 120D is a parent link of IAB node 120D. IAB node 120A can be connected to donor node(s) other than donor node 110 in accordance with some other embodiments of the present application. IAB node 120D can be connected to donor node(s) other than donor node 110 in accordance with some other embodiments of the present application.

IAB node 120C can reach donor node 110 by hopping through IAB node 120D. IAB node 120D is a parent node of IAB node 120C, and IAB node 120C is a child node of IAB node 120D. Link 180D between IAB node 120D and IAB node 120C is a child link of IAB node 120D, and also a parent link of IAB node 120C.

IAB node 120B can reach donor node 110 by hopping through IAB node 120C and IAB node 120D. IAB node 120C and IAB node 120D are upstream nodes of IAB node 120B, and IAB node 120C is a parent node of IAB node 120B. In other words, IAB node 120B is a child node of IAB node 120C. IAB node 120B and IAB node 120C are downstream nodes of IAB node 120D. Link 180E between IAB node 120C and IAB node 120B is a child link of IAB node 120C, and also a parent link of IAB node 120B.

UE 130A is directly connected to IAB node 120A via link 180B, and UE 130B is directly connected to IAB node 120B via link 180F. In other words, UE 130A and UE 130B are served by IAB node 120A and IAB node 120B, respectively. In some other embodiments of the present application, UE 130A and UE 130B may also be referred to as child nodes of IAB node 120A and IAB node 120B, respectively. Link 180B is a child link of IAB node 120A. Link 180F is a child link of IAB node 120B.

Each of IAB node 120A, IAB node 120B, IAB node 120C, and IAB node 120D may be directly connected to one or more UEs in accordance with some other embodiments of the present application.

Each of IAB node 120A, IAB node 120B, IAB node 120C, and IAB node 120D may be directly connected to one or more IAB nodes in accordance with some other embodiments of the present application.

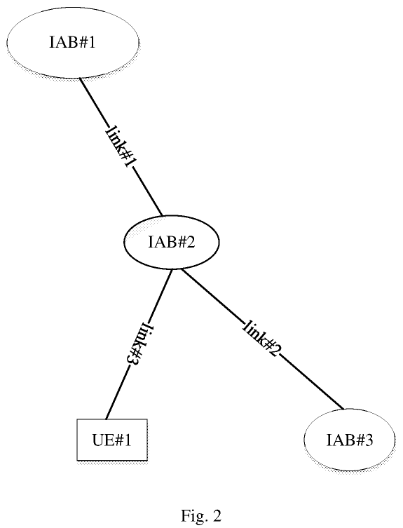

FIG. 2 illustrates an exemplary description of the links between the IAB nodes according to some embodiments of the present disclosure.

In FIG. 2, there are three IAB nodes, IAB #1, IAB #2, and IAB #3, and a UE, i.e. UE #1. IAB #1 is considered as the parent node for IAB #2, and IAB #3 is considered as a child node for IAB #2. UE #1 is the served UE served by IAB #2. From IAB #2's point of view, link #1 is the parent link for IAB #2, and link #2 is the child link of IAB #2, and link #3 is the access link of IAB #2.

The IAB node #2 illustrated in FIG. 2 may include a mobile termination (MT) and a distributed unit (DU). FDM is supported at the IAB node #2. There may be multiple BWPs at IAB MT of the IAB node. The multiple BWPs may have different BWP configurations, which include different starting positions, different RBG sizes, different subcarrier spacing, etc. When FDM is adopted between the parent link, link #1, and the child link, link #2, frequency domain alignment between IAB MT RBG configuration and DU RB set configuration should be considered to improve spectral efficiency.

The present disclosure focus on determining the DU RB set configuration based on one or more BWPs of the IAB MT.

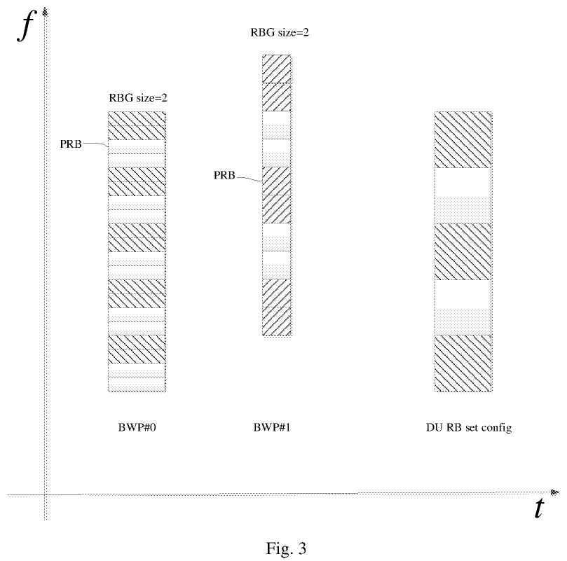

FIG. 3 illustrates an exemplary description of determining the DU RB set configuration according to some embodiments of the present disclosure.

In FIG. 3, there are two BWPs of the IAB MT, i.e. BWP #0 and BWP #1. There is a DU RB set configuration, which is referred to as “DU RB set config” in FIG. 3. The DU RB set is determined based on the two BWPs of the IAB MT. Specifically, the size of the DU RB set is determined with the following steps:
Step 1: determining the PRB size of each BWP of IAB MT based on subcarrier spacing (SCS) of each BWP.
Referring to FIG. 3, the PRB size of BWP #0 is determined based on the SCS of BWP #0, and the PRB size of BWP #1 is determined based on the SCS of BWP #1. For BWP #0, the smallest block in BWP #0 is a PRB, and the size of the PRB may be 15×12=180 KHzin frequency domain, and 1 ms in time domain. For BWP #1, the size of the PRB in BWP #1 may be 30×12=360 KHz in frequency domain, and 0.5 ms in time domain.
Step 2: determining the resource bock group (RBG) size of each BWP of IAB MT based on BWP size and RBG configuration.
The RBG is a set of consecutive virtual resource blocks defined by higher layer parameter rbg-Size configured by the PDSCH configuration (which may be represented with the parameter: PDSCH-Config) and the size of the bandwidth part according to table 1 below:

TABLE 1
Nominal RBG size

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

As can be seen, when the BWP size is from 1-36, the RBG size is 2 according to configuration 1, and the RBG size is 4 according to configuration 2. When the BWP size is from 37-72, the RBG size is 4 according to configuration 1, and the RBG size is 8 according to configuration 2. When the BWP size is from 73-144, the RBG size is 8 according to configuration 1, and the RBG size is 8 according to configuration 16. When the BWP size is from 145-275, the RBG size is 16 according to configuration 1, and the RBG size is 8 according to configuration 16.
In FIG. 3, the RBG size for both BWP is 2 PRBs.
Step 3: determining DU frequency domain granularity to be the largest RBG size among multiple BWPs of IAB MT.
In FIG. 3, the RBG size for BWP #0 is 2 PRBs, and the size of 2 PRBs for BWP #1 is 2×180 KHz, i.e. 360 KHz. The RBG size for BWP #1 is 2 PRBs, and the size of 2 PRBs for BWP #1 is 2×360 KHz, i.e. 720 KHz.
Therefore, the DU frequency domain granularity is 720 KHz.
Step 4: determining DU time domain granularity by the largest symbol/slot length among multiple BWPs of IAB MT.
In FIG. 3, the slot length for BWP #1 is 1 ms, and the slot length for BWP #2 is 0.5 ms, therefore, the DU time domain granularity is 1 ms.
Based on the above four steps, the DU RB set size is determined, which is 720 KHz in frequency domain, and 1 ms in time domain.

As can be seen, the BWP related configuration is necessary for determining the DU RB set configuration.

In some embodiments, the IAB node, for example, the IAB node #2 in FIG. 2, would transmit the BWP related configuration information to the parent node. The BWP related configuration information may at least include the following parameters: the a BWP size for a BWP; a SCS associated with a BWP; and a RBG configuration of a BWP, etc. For example, in FIG. 3, the IAB node may transmit the bandwidth, the SCS of BWP #1 and BWP #1, and the RBG configuration, to the parent node.

In some other embodiments, the IAB node may transmit the following parameters to the parent node: PRB number with respect to a SCS. In some other scenarios, the SCS may be explicitly configured. In still some other scenarios, the SCS is implicitly determined based on SCS of the IAB MT BWP, SCS of the lowest IAB MT BWP, SCS of the DU, or frequency band.

It should be noted that the transmission may also apply to the DU and the CU. That is, the DU may transmit the above parameters to the CU.

Based on the bandwidth, SCS of each BWP of the IAB MT, and the RBG configuration of the IAB MT, the RBG size of each BWP can be determined, and then the largest time/frequency granularity can be determined. In other words, the parent node determines the largest time/frequency granularity based on the BWP related configuration information received from the IAB node. Similarly, the CU determines the largest time/frequency granularity based on the BWP related configuration information received from the DU.

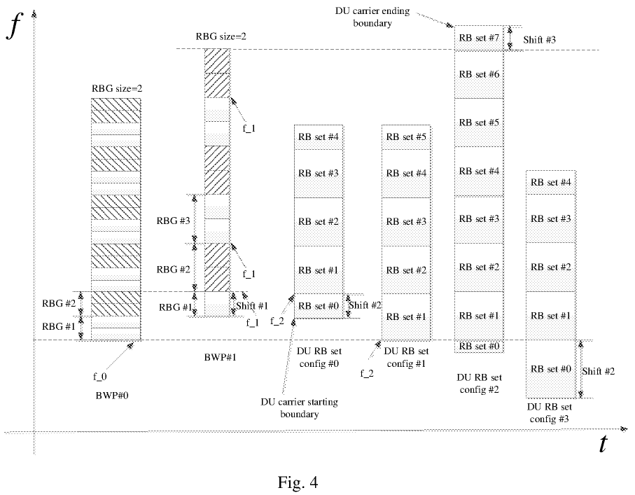

FIG. 4 illustrates an exemplary example for determining the DU RB set configuration according to some embodiments of the present disclosure.

In FIG. 4, there are two BWPs of the IAB MT, i.e. BWP #0 and BWP #1. As can be seen, compared with BWP #1, BWP #0 has lower starting position in frequency domain. A reference boundary marked with “f_0” is determined. A reference starting boundary can be determined to be same as the lowest frequency domain position among all IAB MT BWPs. In some other scenarios, the reference starting boundary can also be determined to be same as the lowest boundary of a carrier, or starting position of SSB, or stating position of CORESET #0, or explicitly configured.

A granularity f_g is determined based on the largest RBG size in frequency domain among all BWPs of the IAB MT. In FIG. 4, suppose the RBG size in frequency domain in BWP #0 is 360 KHz, the RBG size in frequency domain in BWP #1 is 720 KHz, the largest RBG size is 720 KHz, and 720 KHz is determined as the frequency domain granularity f_g.

Possible ending boundary of the first RBG of each BWP of IAB MT is:

$$f\_ 1 = f\_ 0 + n \times f\_g , n = 0 , 1 , 2 , …$$

For BWP #1, the ending boundary of the first RBG is the nearest f_1 which is not smaller than the starting frequency domain position of BWP #1.

If the size of RBG #1 is not equal to the frequency domain granularity f_g, RBG #1 may also be referred to as Shift #1, as shown in FIG. 4.

At the parent node side, the parent node determines the DU RB set configuration based on the BWP related information of the IAB MT. Specifically, the DU RB set configurations should be aligned with the BWP configurations in frequency domain for FDM multiplexing mode between the IAB node's parent link and child link.

The present disclosure proposes to configure the DU RB set as follows:

Possible ending or starting position (which is marked as f_2 in FIG. 4) in frequency domain of the first RB set is calculated as follows:

$$f\_ 2 = f\_ 0 + n \times f\_g , n = 0 , 1 , 2 , …$$

where f_2 is larger than or equal to the DU carrier starting boundary.

For example, for DU RB set config #0, f_2=f_0+f_g; for DU RB set config #1, f_2=f_0, for DU RB set config #2, f_2=f_0, and for DU RB set config #3, f_2=f_0.

The resource shift #2 is determined by the starting frequency of the DU carrier (i.e., the starting boundary of the DU RB set) and f_2. Specifically, the size of shift #2 is from the starting frequency of the DU carrier to f 2, or from f_2 to the starting frequency of the DU carrier depending on the value of these two parameters. For example, shift #2 of DU RB set config #0 and DU RB set config #3 is marked in FIG. 4. The size of shift #2 may be different from the granularity f_g.

According to different scenarios, the last RB set is determined differently, when the ending boundary of an IAB DU carrier is larger than the ending boundary of all BWPs, the last RB set may be determined by the difference between the ending boundary of an IAB DU carrier and the largest ending boundary of all BWPs, for example, the RB set #7 in DU RB set config #2 is determined by the difference. The RB set #7 is considered as a shift, and is referred to as “shift #3” in FIG. 4. The size of shift #3 may be different from the granularity f_g.

When the ending boundary of an IAB DU carrier is not larger than the ending boundary of all BWPs, for example, the ending boundary of an IAB DU carrier for DU RB set config #2 is not larger than the ending boundary of BWP #0 or BWP #1, the last RB set #4 is determined based on the ending boundary of an IAB DU carrier, a reference starting boundary, the largest RBG size among all BWPs of the IAB MT. Specifically, the size of the last RB set equals to the remainder of dividing (the ending boundary of an IAB DU carrier—a reference starting boundary) by the largest RBG size. The size of the last RB set may be different from the granularity Lg.

It should be noted that the DU RB set configuration may include none, one, two of the shifts, shift #2, and shift #3. For example, DU RB set configuration #1 do not include any shifts, DU RB set configuration #3 include shift #2, and DU RB set configuration #2 includes both shifts.

Based on the above calculation, the shift #2 (if any), shift #3 (if any), the RB sets with the largest RBG size are all determined, thus the DU RB set configuration is determined.

For MT frequency shift, e.g. shift #1, the BWP starting position configuration being implemented based on the starting position can only be f_1.

In some embodiments, when a time domain resource is used for FDM multiplexing mode between the IAB node's parent link and child link, and the RB grouping is updated. The update is that the starting boundary of the first RB group with size f_g should be f_1. The determination of time domain resource for FDM mode can be explicit or implicit.

Regarding DU frequency shift #2, which is also marked as RB set #0 in FIG. 4, is indicated from the CU to the IAB DU, or from the IAB node's parent node. When the RB set #0 does not overlap with any resources of the BWP of the IAB MT, i.e. the RB set #0 is not used for FDM, the RB set #0 may be configured as hard resource. For example, the RB set #0 in DU RB set config #2 may be configured as hard. The RB set #0 in DU RB set config #0, which overlaps with the BWP of the IAB MT, thus cannot be configured as hard.

Regarding DU frequency shift #3, which is marked as the last RB set in FIG. 4, for example, RB set #7 in DU RB set config #2, is indicated from the CU to the IAB DU, or from the IAB node's parent node. When the last RB set does not overlap with any resources of the BWP of the IAB MT, i.e. the last RB set is not used for FDM, the last RB set may be configured as hard resource. For example, the RB set #7 in DU RB set config #2 may be configured as hard.

The reference SCS of the frequency domain shift can be explicitly configured or same as the SCS associated with FDM multiplexing mode.

The above solutions for determining the DU RB set configuration is static. In some other scenarios, the determining of the DU RB set configuration can be dynamic.

The active BWP includes downlink (DL) active BWP and uplink (UL) active BWP. The present disclosure proposes that the transmission direction at the IAB node's parent link for FDM multiplexing mode determines whether it is DL active BWP or UL active BWP.

In other words, when the IAB node performs simultaneous reception, the transmission direction at the IAB node's parent link is DL, then the active BWP is DL active BWP. When the IAB node performs simultaneous transmission, the transmission direction at the IAB node's parent link is UL, then the active BWP is UL active BWP.

In this scenario, the DU RB set configuration may also include DU frequency domain shift, i.e. shift #2 and shift #3 as shown in FIG. 4, and they are calculated in the same manner.

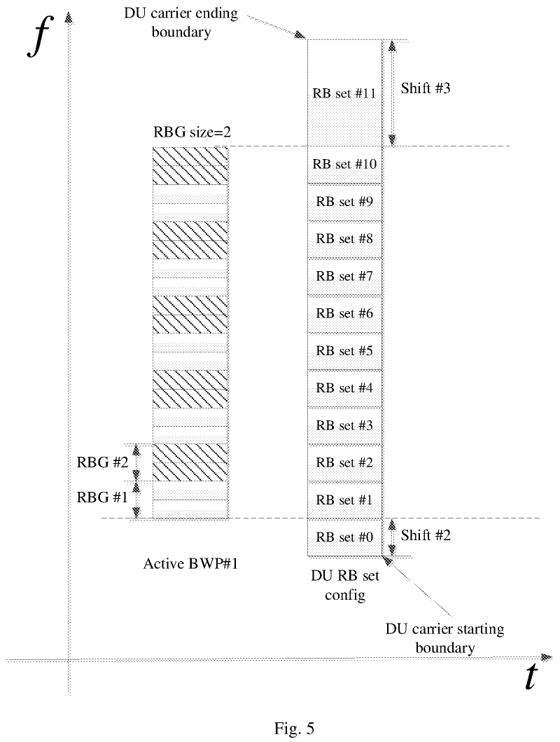

FIG. 5 illustrates another exemplary description of determining the DU RB set configuration according to some embodiments of the present disclosure.

In FIGS. 5, the DU RB set configuration is determined based on the active BWP #1 at IAB MT.

In FIG. 5, there is one active BWP, active BWP #1, therefore, the size of the DU RB set is determined according to active BWP #1. For example, the PRB size of BWP #1 is 180 KHz in frequency domain, 1 ms in time domain, and the RBG size is 2. Then the size of the DU RB set is 360 KHz in frequency domain, 1 ms in time domain.

Shift #2 (i.e. RB set #0) is determined based on the starting position in frequency domain of active BWP #1 and the starting boundary of the DU carrier, and shift #3 (i.e. RB set #11) is determined based on the ending position in frequency domain of active BWP #1 and the ending boundary of the DU carrier. For shift #3, it can be expressed in number of RBs with respect to a reference SCS.

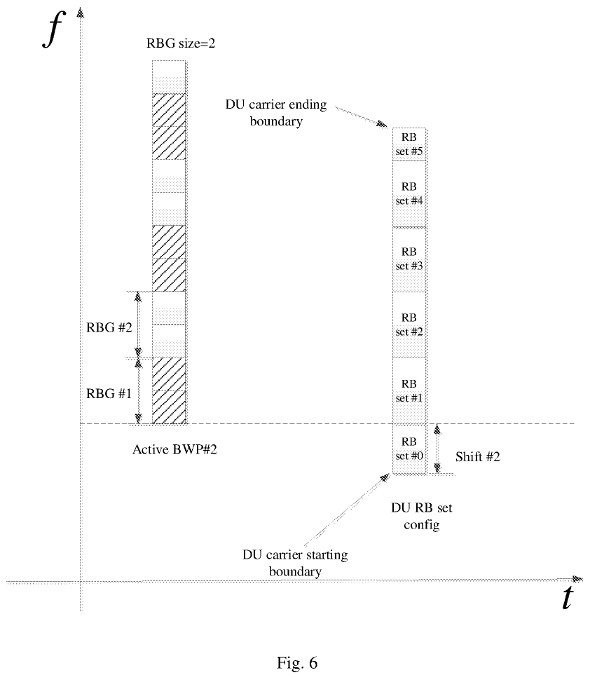

FIG. 6 illustrates another exemplary description of determining the DU RB set configuration according to some embodiments of the present disclosure.

In FIGS. 6, the DU RB set configuration is determined based on the active BWP #2 at IAB MT.

In FIG. 6, there is one active BWP, active BWP #2, therefore, the size of the DU RB set is determined according to active BWP #2. For example, the PRB size of BWP #1 is 360 KHz in frequency domain, 0.5 ms in time domain, and the RBG size is 2. Then the size of the DU RB set is 720 KHz in frequency domain, 0.5 ms in time domain.

Shift #2 (i.e. RB set #0) is determined based on the starting position in frequency domain of active BWP #2 and the starting boundary of the DU carrier, and the last RB set #5 is determined based on the ending boundary of an IAB DU carrier, a reference starting boundary, the RBG size of active BWP of the IAB MT. Specifically, the size of the last RB set equals to the remainder of dividing (the ending boundary of an IAB DU carrier—a reference starting boundary) by the RBG size.

For the last RB set in FIG. 6, it can be expressed in number of RBs with respect to a reference SCS

In both FIGS. 5 and 6, there is a one-one mapping relation between IAB MT BWP index and DU frequency domain RB set configuration (shift #2 and shift #3). The BWP index may be DL BWP index, UL BWP index, or a joint index based on DL BWP index and the UL BWP index.

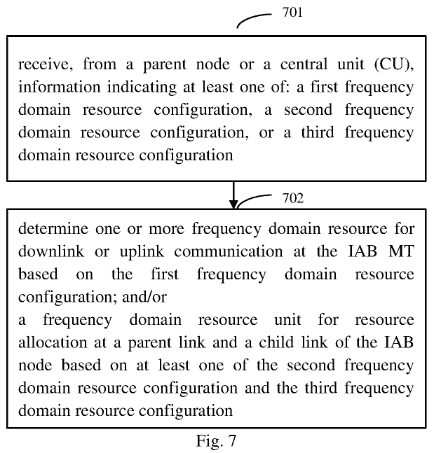

FIG. 7 illustrates a method for wireless communication according to a preferred embodiment of the subject disclosure, which may be implemented on an IAB node, for example, IAB #2 in FIG. 2.

In step 701, the IAB node receives from the parent node or the CU, information indicating at least one of: a first frequency domain resource configuration associated with at least one BWP of an IAB MT; a second frequency domain resource configuration associated with a RB set configuration of an IAB DU; and a third frequency domain resource configuration associated with the RB set configuration of the IAB DU. For example, the first frequency domain resource may be shift #1 in FIG. 4, the second frequency domain resource may be shift #2, and the third frequency domain resource may be shift #3. Correspondingly, the parent node or the CU, transmits the information to the IAB node.

In step 702, the IAB node determines one or more frequency domain resource for downlink or uplink communication at the IAB MT based on the first frequency domain resource configuration; and/or a frequency domain resource unit for resource allocation at a parent link and a child link of the IAB node based on at least one of the second frequency domain resource configuration and the third frequency domain resource configuration. That is, the IAB node determines the frequency domain resource at IAB MT based on shift #1, and determines the RB set at a parent link and a child link of the IAB node based on shift #2 and/or shift #3.

In some embodiments, the first frequency domain resource configuration is based on the size of a first RBG of the at least one BWP of the IAB MT. For example, in FIG. 4, the size of shift #1 is identical to the size of RBG #1.

In some embodiments, the second frequency domain resource configuration is based on the size of the first RB set of the IAB DU, and the size is different from a size of other RB sets of the IAB DU. For example, in FIG. 4, the size of shift #2 is identical to the size of RB set #0. The size of shift #2 is different from the size of other RB sets, such as RB set #1.

In some embodiments, the third frequency domain resource configuration is based on the size of a last RB set of the IAB DU, and the size is different from size of other RB sets of the IAB DU. For example, in FIG. 4, the size of the last RB set #4 in DU RB set config #0 is different from the size of other RB sets, such as RB set #1.

In some embodiments, wherein the first frequency domain resource is determined based on at least one of a starting boundary of the at least one BWP configuration and a reference starting boundary, and a largest RBG size among all BWPs of the IAB MT. For example, in FIG. 4, the size of RBG #1 in BWP #1 is determined based on the starting boundary of BWP #1, the reference starting boundary, and the largest RBG size.

In some embodiments, the second frequency domain resource is determined based on at least one of a starting boundary of an IAB DU carrier, a reference starting boundary and a largest RBG size among all BWPs of the IAB MT. For example, in FIG. 4, the size of RB set #0 is determined based on the starting frequency of the DU carrier, a reference starting boundary f_0, and a largest RBG size.

In some embodiments, the third frequency domain resource is determined based on at least one of an ending boundary of an IAB DU carrier, a reference starting boundary, a largest RBG size among all BWPs of the IAB MT, and an ending boundary of the at least one BWP of the IAB MT. For example, in FIG. 4, the size of RB set #7 is determined by the difference between the ending boundary of an IAB DU carrier and the largest ending boundary of all BWPs.

In some embodiments, the reference starting boundary is explicitly configured, implicitly determined based on a starting frequency domain position of a carrier, implicitly determined based on a starting frequency domain position of synchronization signal/physical broadcast channel (SSB), or implicitly determined based on starting frequency domain position of a lowest indexed BWP of the IAB MT.

In some embodiments, the second frequency domain resource is determined as hard resource in the case that the second frequency domain resource does not overlap with any PRB or any active BWP of the IAB MT. For example, in FIG. 4, the RB set #0 in DU RB set config #2 may be configured as hard.

In some embodiments, the third frequency domain resource is determined as hard resource in the case that the third frequency domain resource does not overlap with any PRB or any active BWP of the IAB MT. For example, in FIG. 4, the RB set #7 in DU RB set config #2 may be configured as hard.

In some embodiments, at least one of the first frequency domain resource, second frequency domain resource and the third frequency domain resource is applied to the time domain resource when the time domain resource is associated with frequency domain multiplexing between a parent link and a child link of the IAB node.

In some embodiments, at least one of the second frequency domain resource and the third frequency domain resource is associated with a BWP index of the IAB MT. The BWP index includes a DL BWP index, an UL BWP index, or a joint index based on the DL BWP index and the UL BWP index.

In some embodiments, the IAB node further receive, from the CU or the parent node, a mapping relationship between the BWP index and at least one of the second frequency domain resource and the third frequency domain resource.

In some embodiments, the IAB node further determine the BWP index to be a DL active BWP index or a UL active BWP index is based on a transmission direction on a parent link of the network node.

In some embodiments, the first frequency domain resource, the second frequency domain resource, and the third frequency domain resource is indicated by a number of PRBs associated with a reference SCS. In some embodiments, the SCS is explicitly configured, implicitly determined based on SCS of the IAB MT BWP, or SCS of an IAB MT BWP with the lowest frequency band.

The IAB node may transmit information to a parent node or a CU, and the information including at least one of the following: one or more BWP configurations; and a PRB number associated with a reference SCS. In some embodiments, the one or more BWP configurations include at least one of the following: a BWP size for a BWP; a SCS associated with a BWP; and a resource block group (RBG) configuration of a BWP.

In some embodiments, the information is used to determine a size of a RB set for an IAB DU. In some embodiments, the IAB node transmit the reference SCS with the PRB number.

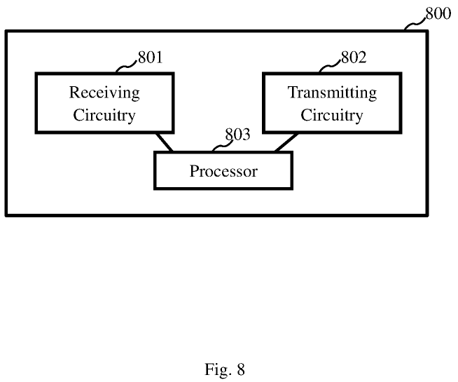

FIG. 8 illustrates an exemplary block diagram of an apparatus 900 according to some embodiments of the present application. In some embodiments of the present application, the apparatus 900 may be an IAB node or other devices having similar functionalities, which can at least perform the method illustrated in FIG. 7.

As shown in FIG. 8, the apparatus 800 may include at least one receiving circuitry 801, at least one non-transitory computer-readable medium, and at least one transmitting circuitry 802, and at least one processor 803 coupled to the at least one receiving circuitry 801, the at least one transmitting circuitry 802, the at least one non-transitory computer-readable medium. Although FIG. 8 shows that the at least one receiving circuitry 801, the at least one transmitting circuitry 802, the at least one non-transitory computer-readable medium are directly coupled with the at least one processor 803, it should be understand that all the components in apparatus 800 can be coupled to a data bus so as to be connected and communicate with each other.

Although in FIG. 8, elements such as receiving circuitry 801, transmitting circuitry 802, and processor 803 are described in the singular, the plural is contemplated unless limitation to the singular is explicitly stated. In some embodiments of the present application, the at least one receiving circuitry 801 and the at least one transmitting circuitry 802 can be combined into a single device, such as a transceiver. In certain embodiments of the present application, the apparatus 800 may further include an input device, a memory, and/or other components.

In some embodiments of the present application, the at least one non-transitory computer-readable medium may have stored thereon computer-executable instructions which are programmed to cause the at least one processor 803 to implement the operations of the methods, for example as described in view of FIG. 7, with the at least one receiving circuitry 801 and the at least one transmitting circuitry 802. For example, when executed, the instructions may cause the at least one processor 803 to receive, with the at least one receiving circuitry 801, a first signaling via a first link, wherein the first signaling indicates a first time domain resource configuration of at least one multiplexing mode for the first link and a second link. The instructions may further cause the at least one processor 803 to determine time domain resources associated with each multiplexing mode of the at least one multiplexing mode based on the first time domain resource configuration.

The method of the present application can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present application has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present application by simply employing the elements of the independent claims. Accordingly, the embodiments of the present application as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. An integrated access and backhaul (IAB) node, comprising:
at least one memory; and
at least one processor coupled with the at least one memory and configured to cause the IAB node to:
receive, from a parent node or a central unit (CU), information indicating at least one of:
a first frequency domain resource configuration associated with at least one bandwidth part (BWP) of an IAB mobile terminal (MT);
a second frequency domain resource configuration associated with a resource block (RB) set configuration of an IAB distributed unit (DU); or
a third frequency domain resource configuration associated with the RB set configuration of the IAB DU;
determine one or more frequency domain resource for downlink or uplink communication at the IAB MT based on the first frequency domain resource configuration; and/or
determine a frequency domain resource unit for resource allocation at a parent link and a child link of the IAB node based on at least one of the second frequency domain resource configuration and the third frequency domain resource configuration.

2. The IAB node of claim 1, wherein the first frequency domain resource configuration is based on a size of a first RBG of the at least one BWP of the IAB MT.

3. The IAB node of claim 1, wherein the second frequency domain resource configuration is based on a size of a first RB set of the IAB DU, and the size is different from a size of other RB sets of the IAB DU.

4. The IAB node of claim 1, wherein the third frequency domain resource configuration is based on size of a last RB set of the IAB DU, and the size is different from size of a other RB sets of the IAB DU.

5. The IAB node of claim 1, wherein the first frequency domain resource is determined based on at least one of a starting boundary of the at least one BWP configuration and a reference starting boundary, and a largest RBG size among all BWPs of the IAB MT.

6. The IAB node of claim 1, wherein the second frequency domain resource is determined based on at least one of a starting boundary of an IAB DU carrier, a reference starting boundary and a largest RBG size among all BWPs of the IAB MT.

7. The IAB node of claim 1, wherein the third frequency domain resource is determined based on at least one of an ending boundary of an IAB DU carrier, a reference starting boundary, a largest RBG size among all BWPs of the IAB MT and an ending boundary of the at least one BWP of the IAB MT.

8. The IAB node of claim 5, wherein the reference starting boundary is explicitly configured, implicitly determined based on a starting frequency domain position of a carrier, implicitly determined based on a starting frequency domain position of synchronization signal/physical broadcast channel (SSB), or implicitly determined based on starting frequency domain position of a lowest indexed BWP of the IAB MT.

9. The IAB node of claim 1, wherein the second frequency domain resource is determined as a hard resource in response to the second frequency domain resource not overlapping with any PRB or any active BWP of the IAB MT.

10. The IAB node of claim 1, wherein at least one of the first frequency domain resource, second frequency domain resource and the third frequency domain resource is applied to a time domain resource when the time domain resource is associated with frequency domain multiplexing between a parent link and a child link of the IAB node.

11. The IAB node of claim 1, wherein at least one of the second frequency domain resource and the third frequency domain resource is associated with a BWP index of the IAB MT.

12. The IAB node of claim 11, wherein the BWP index includes a downlink (DL) BWP index, an uplink (UL) BWP index, or a joint index based on the DL BWP index and the UL BWP index.

13. The IAB node of claim 11, wherein the at least one processor is configured to cause the IAB node to:
receive, from the CU or the parent node, a mapping relationship between the BWP index and at least one of the second frequency domain resource and the third frequency domain resource.

14. The IAB node of claim 1, wherein the first frequency domain resource, the second frequency domain resource, and the third frequency domain resource is indicated by a number of PRBs associated with a reference SCS.

15. An integrated access and backhaul (IAB) node, comprising:
at least one memory; and
at least one processor coupled with the at least one memory and configured to cause the IAB node to:
transmit information to a parent node or a central unit (CU), and the information including at least one of the following:
one or more bandwidth part (BWP) configurations; or
a physical resource block (PRB) number associated with a reference subcarrier spacing (SCS).

16. A method performed by an integrated access and backhaul (IAB) node, the method comprising:
transmitting information to a parent node or a central unit (CU), and the information including at least one of the following:
one or more bandwidth part (BWP) configurations; or
a physical resource block (PRB) number associated with a reference subcarrier spacing (SCS).

17. A method performed by an integrated access and backhaul (IAB) node, the method comprising:
receiving, from a parent node or a central unit (CU), information indicating at least one of:
a first frequency domain resource configuration associated with at least one bandwidth part (BWP) of an IAB mobile terminal (MT);
a second frequency domain resource configuration associated with a resource block (RB) set configuration of an IAB distributed unit (DU); or
a third frequency domain resource configuration associated with the RB set configuration of the IAB DU;
determining one or more frequency domain resource for downlink or uplink communication at the IAB MT based on the first frequency domain resource configuration; and
determining a frequency domain resource unit for resource allocation at a parent link and a child link of the IAB node based on at least one of the second frequency domain resource configuration and the third frequency domain resource configuration.

18. The method of claim 17, wherein the first frequency domain resource configuration is based on a size of a first RBG of the at least one BWP of the IAB MT.

19. The method of claim 17, wherein the second frequency domain resource configuration is based on a size of a first RB set of the IAB DU, and the size is different from a size of other RB sets of the IAB DU.

20. The IAB node of claim 14, wherein the reference SCS is configured.
